(19) United States
(12) Patent Application Publication
(10) Pub. No.: US 2020/0387953 A1
(43) Pub. Date: Dec. 10, 2020

(54) SERVICE COORDINATION DEVICE AND SERVICE COORDINATION METHOD

(71) Applicant: Nippon Telegraph and Telephone Corporation, Tokyo (JP)

(72) Inventors: Hiroyuki Tanaka, Musashino-shi, Tokyo (JP); Kensuke Takahashi, Musashino-shi, Tokyo (JP); Naoyuki TANJI, Musashino-shi, Tokyo (JP); Naoki Take, Musashino-shi, Tokyo (JP); Nobuo Onai, Musashino-shi, Tokyo (JP); Hiroyuki Yazaki, Musashino-shi, Tokyo (US); Hiroshi Kato, Musashino-shi, Tokyo (US)

(21) Appl. No.: 16/971,164

(22) PCT Filed: Feb. 13, 2019
(86) PCT No.: PCT/JP2019/005018

§ 371 Date: Aug. 19, 2020

(30) Foreign Application Priority Data
Feb. 19, 2018 (JP) 2018-026596

(51) Int. Cl. G06Q 30/06; G06Q 10/06; G06Q 10/10

(52) U.S. Cl. CPC G06Q 30/0635; G06Q 10/103; G06Q 10/0633; G06Q 10/06316

(57) ABSTRACT

A service coordination device including: an order execution unit that is configured to execute a coordinated service order that has been registered in and is read from an order management database in order to process an instance of the coordinated service generated over a utilized resource of the coordinated service; and an exclusion control unit that is configured to carry out exclusion control among coordinated service orders, wherein when there are conflicting coordinated service orders targeting to process a same instance, before the conflicting coordinated service orders are executed by the order execution unit at the same time, the exclusion control unit is configured to prioritize a coordinated service order that is executed first among the conflicting coordinated service orders and prevents other ones of the conflicting coordinated service orders from being executed.

### TECHNICAL FIELD

The present invention relates to a service coordination device and service coordination method.

### BACKGROUND ART

Although service providers separately provide individual wholesale services such as network (NW), cloud (Cloud), and application (APL) services, there is now an increasing trend to build coordinated services that link wholesale services among service providers. In coordinated services, various wholesale services are utilized via an API (application programming interface) according to “coordinated service orders” that are orders for executing services.

Patent Literature 1 describes, as a method for reserving resources of multiple network services, a service reservation method that enables a service reservation that not only avoids setting aside resources that are unlikely to be used but also avoids an increase in the processing load of an operation system (OpS) of network providers. Non-patent Literature 1 teaches how, when services are to be linked among multiple providers, catalogs that define service specifications for the services are prepared. Furthermore, as a method of describing these catalogs, the Non-patent Literature 1 teaches an architecture that separates components from action rules. In this way, incorporation of new services that may be linked and compliance with APIs can be realized in a flexible manner.

### CITATION LIST

### Patent Literature

Patent literature 1: Japanese Unexamined Patent Application Publication No. 2017-143426

### Non-Patent Literature

Non-patent literature 1: Kensuke Takahashi, et al., “A System Architecture for Flexibly Coordination Fulfillment among Multiple Service Providers”, The IEICE Communications Society Conference, Sep. 12, 2017.

### SUMMARY OF THE INVENTION

### Technical Problem

Because coordinated services employ complex configurations that link multiple wholesale services together, order management concerning when and what kind of coordinated service orders are to be received and how resources are allowed to be used become complex as well. Conventional order management systems, however, have not been able to fill the needs of users with regards to order management of complex coordinated services.

One issue, for example, has been that when a coordinated service order is issued, a conflict can arise with another coordinated service order that use the same resources at the same time. Dealing with such a conflicting state in advance has not been possible with conventional order management systems, resulting in conflicting processes to be carried out.

The object of this invention, therefore, is to appropriately manage orders of coordinated services that link multiple wholesale services.

### Solution to Problem

In order to solve the above problems, a service coordination device of the of the invention has the following features.

The service coordination device of the present invention includes (a) an order receiving unit configured to accept a coordinated service order, wherein the coordinated service order executes a coordinated service linking multiple services; (b) an order management unit configured to register the coordinated service order received by the order receiving unit in an order management database; (c) an order execution unit configured to execute the registered coordinated service order that is read from the order management database so as to process an instance of the coordinated service generated over a utilized resource of the coordinated service; and (d) an exclusion control unit configured to carry out exclusion control among coordinated service orders by prioritizing a coordinated service order that is executed first among conflicting coordinated service orders targeting to process a same instance and preventing other ones of the conflicting coordinated service orders from being executed before the conflicting coordinated service orders are executed by the order execution unit at the same time.

In this way, exclusion control is carried out so that conflicting coordinated service orders that target the same instance for processing are not executed at the same time, making it possible to appropriately manage orders of coordinated services that link multiple wholesale services.

In the service coordination device of the present invention, the order execution unit is further configured to set the coordinated service order that is read from the order management database and executed to an InProgress state, wherein when a new coordinated service order is received by the order receiving unit, the exclusion control unit is configured to prevent the new coordinated service order from being registered in the order management database if there is at least one conflicting coordinated service order that is in an InProgress state.

In this way, exclusion control among coordinated service orders is carried out appropriately when a new coordinated service order is received.

In the service coordination device of the present invention, the order execution unit is further configured to set the coordinated service order that is read from the order management database and executed to an InProgress state, wherein when a specific coordinated service order is read from the order management database to be executed, the exclusion control unit is configured to prevent the specific coordinated service order from being executed if there is a conflicting coordinated service order that is in an InProgress state.

In this way, even if there is no problem at the time of accepting a new coordinated service order, at the time of subsequent execution, exclusion control among coordinated service orders is carried out appropriately.

In the service coordination device of the present invention, the order receiving unit is further configured to individually register as an Acknowledged state a reserved order with a specified order execution date and time and an immediate order not specified with an order execution date and time in the order management database, wherein when the order receiving unit receives a new immediate order, the exclusion control unit is configured to prevent the new immediate order from being registered in the order management database if there is a conflicting immediate order that is in an Acknowledged state.

In this way, by narrowing down the immediate order that is registered in an order management database to one order for every instance, exclusion control is carried out among immediate orders that are executed immediately.

In the service coordination device of the present invention, when an order modification request to modify either an order execution date and time or a processing content of an instance for a reserved order registered in the order management database is received, the order management unit is configured to search the corresponding reserved order from the order management database, and if the corresponding reserved order is not registered in the order management database or is not in an Acknowledged state, to not reflect the order modification request in the order management database.

In this way, it is possible to provide highly flexible reservation management that allows a content of a reserved order to be modified even after the reserved order specified with an order execution date and time has been registered.

### Advantageous Effects of the Invention

According to the invention, it is possible to appropriately manage an order of a coordinated service linking multiple wholesale services.

### BRIEF DESCRIPTION OF DRAWINGS

FIG. 1 is a block diagram of a reservation management system according to an embodiment of the disclosure.

FIG. 2 is an explanatory drawing illustrating coordinated service orders that are in a conflicting state according to an embodiment of the disclosure.

FIG. 3 is a schematic diagram of an order management database according to an embodiment of the disclosure.

FIG. 4 is a table used by an order execution unit to identify the order state of a coordinated service order from the order states of wholesale service orders according to an embodiment of the disclosure.

FIG. 5 is a time-sequential table that illustrates the transition of a reserved order from an Acknowledged state to a Completed state according to an embodiment of the disclosure.

FIG. 6 is a time-sequential table showing the transition of time from when there is a reserved order in an Acknowledged state to when a new immediate order that is initially in an Acknowledged state transitions to a Completed state according to an embodiment of the disclosure.

FIG. 7 is a time-sequential table that begins from when there is a reserved order in an InProgress state to when a new immediate order is set to a Held state according to an embodiment of the disclosure.

FIG. 8 is a time-sequential table showing an occasion when a reserved order transitions to an InProgress state before a new immediate order can be executed according to an embodiment of the disclosure.

FIG. 9 is a flowchart showing the steps that are followed when a new add-type order is issued as an order registration request according to an embodiment of the disclosure.

FIG. 10 is a flowchart showing steps that are followed when an order modification request for a registered coordinated service order is received according to an embodiment of the disclosure.

FIG. 11 is a flowchart showing the process where at least one reserved order whose order execution date and time has arrived is read from the order management DB 15 according to an embodiment of the disclosure.

FIG. 12 is a flowchart showing details of a process for executing at least one reserved order according to an embodiment of the disclosure.

FIG. 13 is a flowchart showing the process when a new update-type order or a new delete-type order is issued as an order registration request according to an embodiment of the disclosure.

FIG. 14 is a flowchart showing details of an exclusion check process at time of receipt according to an embodiment of the disclosure.

FIG. 15 is a flowchart showing details of an exclusion check process at time of execution according to an embodiment of the disclosure.

### DESCRIPTION OF EMBODIMENTS

An embodiment of the present invention will be described in detail with reference to drawings.

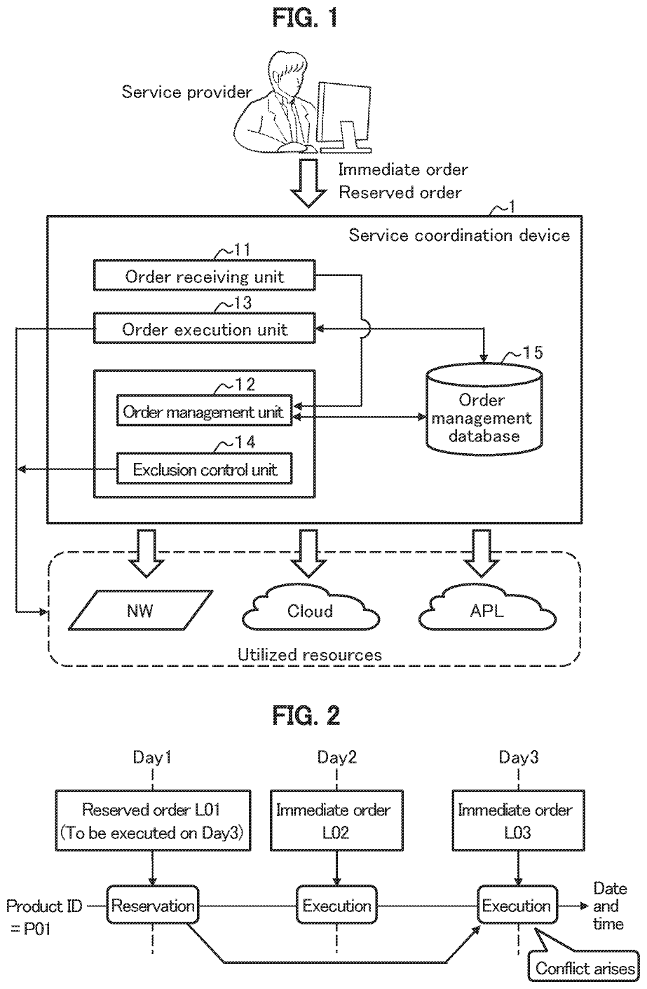

FIG. 1 is a block diagram of a reservation management system. Basic terms are defined as follows.

A “utilized resource” is a resource that is used to provide a service. Examples include communication resources such as a SIM (a subscriber identity module) and computer resources provided as virtual servers via the cloud. Utilized resources are provided as individual “wholesale services” such as a network, a cloud, and an application.

A “coordinated service” is a service that is provided to a service provider in which multiple wholesale services are linked and bundled together. Note that because a coordinated service has multiple wholesale services as ‘subordinates’, a coordinated service and a wholesale service are sometimes called a “parent service” and a “child service” respectively.

A “service order” is an order (an application) from a service provider for executing various processes on a utilized resource. A service order is, for example, configured from a structured file that includes account information (Billing Account), a catalog (Product Offering), and user configurable parameters (characteristic).

A “coordinated service order” is a service order to realize a coordinated service over a utilized resource. A “wholesale service order” is a service order to realize individual wholesale services that are linked together by a coordinated service order. For example, a first wholesale service order for building a virtual machine environment using a cloud service, a second service wholesale order for activating a SIM using a mobile communication service, and a third wholesale service order for receiving user registration using an application service are linked together by a single coordinated service order.

In the explanation that follows, in order to distinguish between individual coordinated service orders, an identifier for a coordinated service order, a “coordinated service order ID”, is used. Furthermore, from the perspective of execution times of service orders, a service order may be categorized either as a reserved order or an immediate order. A reserved order is a service order with an order execution date and time that is specified at a future time. An immediate order is a service order without a specified order execution date and time that is executed immediately.

In the reservation management system, after a coordinated service order (either a reserved order or an immediate order) is received by the service coordination device 1 from a service provider, the coordinated service order is materialized (in other words, instantiated) over the utilized resources of individual wholesale services that make up the coordinated service order.

The service coordination device 1 is configured from a computer including a CPU (a central processing unit), memory, storage (a storage part) such as a hard disc, and a network interface.

Through executing a program (referred to as an application or app) that is loaded in the memory with the CPU, the computer operates a control part (a control means) configured from individual processing parts.

The service coordination device 1 includes an order receiving unit 11, an order management unit 12, an order execution unit 13, an exclusion control unit 14, and an order management database 15 (also referred to as an “order management DB 15”). The order receiving unit 11 accepts coordinated service orders from service providers. Note that for the exchange of coordinated service orders, an application programming interface (API) such as that defined in the technical specification TMF622 issued by the standards organization TMF (TeleManagement Forum) may be used.

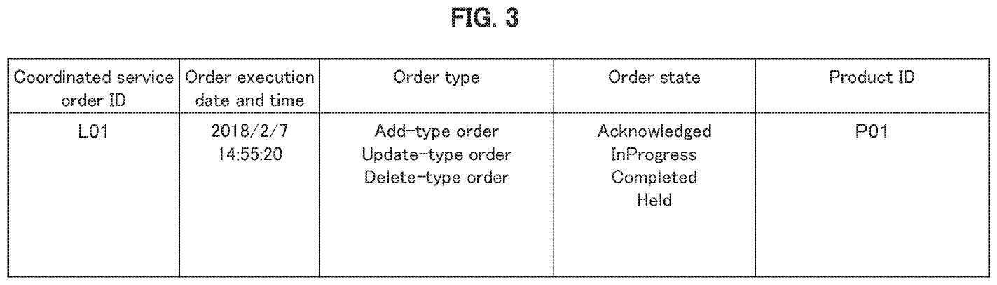

The order management unit 12 reflects the coordinated service order that has been received by the order receiving unit 11 in the order management DB 15 by using various types of information used for order management that will be described later with reference to FIG. 3. In order words, the order management unit 12 registers a new coordinated service order in the order management DB 15 of FIG. 3 in accordance with an order registration request that has been received by the order receiving unit 11. Furthermore, the order management unit 12 modifies a coordinated service order registered in the order management DB 15 in accordance with an order modification request that has been received by the order receiving unit 11. Yet further, when deleting a record from the order management DB 15, an order modification request is used to allow a service provider to specify the record.

When the current time reaches the order execution date and time of a reserved order that is registered in the order management DB 15, the order execution unit 13 is read from the order management DB 15 and executed.

Since the execution data and time of an immediate order is not specified, an immediate order is read from the order management DB 15 and executed without delay. Note that the order execution process includes an interpretation processing of a “catalog” that is as specified in the technical specification TMF 622. This catalog is also managed by the order management DB 15 and is data that is read therefrom when an order is executed.

The exclusion control unit 14 detects a conflicting state before the conflicting state occurs. A conflicting state is where the same utilized resource is used by multiple coordinated service orders at the same time through processing of order executions by the order execution unit 13. Furthermore, the exclusion control unit 14 circumvents a conflicting state beforehand by carrying out exclusion control so that at any point in time, a utilized resource is used by only one coordinated service order.

FIG. 2 is a diagram illustrating a conflicting state between coordinated service orders. Three coordinated service orders L01, L02, and L03 use the same resource. The reserved service order L01 that is received by the order receiving unit 11 on day one specifies day three as the order execution date and time. The immediate order L02 that is received by the order receiving unit 11 on day two and the immediate order L03 that that is received by the order receiving unit 11 on day three do not specify an order execution date and time.

The immediate order L02 of day two can be executed without delay without generating a conflicting state because there are no other orders executed at the same time.

On day three, however, a conflict arises over the utilized resource because the timing of accepting and executing the immediate order L03 overlaps with the timing of executing the reserved order L01 in accordance with the order execution date and time thereof.

Note that in FIG. 2, a description “Product ID=P01” is used to indicate that the same resource is being used. The terms “product” and “product ID” are as follows.

A “product” is a coordinated service order that is instantiated over a utilized resource. In other words, a product is a coordinated service order that has been configured to be in an executable state. A “product ID” is an identifier for distinguishing each product. Note that in the technical specification “TMF622 Product Order Resource”, there is a description of an instance (a “Product”) created from a coordinated service order (=“Product Order”).

The determination of whether two utilized resources are the same resource or different resources will now be described. As an example, a case is considered where an execution file A in which a procedure of a coordinated service order is described with a program code is executed on a physical computer X.

A case may occur where two execution files A are launched at different times. When this happens, process A1 that first instantiates the execution file A and process A2 that later instantiates the execution file A uses different memory spaces on the same memory chip of computer X. Since different memory spaces are used, the utilized resource of process A1 and the utilized resource of process A2 are different. Therefore, the two processes are executed using different utilized resources.

And since the utilized resources are different, even if the coordinated service order of process A1 and the coordinated service order of process A2 use the same physical computer X at the same time, a conflict does not arise.

Because an instantiated process corresponds to a product, separate product IDs are allocated to process A1 and process A2. If there exists two reserved orders that specify the product ID of process A1 and have the same order execution date and time, a conflict arises because the two reserved orders handle the same utilized resource.

FIG. 3 is a schematic diagram of the order management DB 15. The order management DB 15 manages coordinated service order IDs, order execution date and times, order types, order states, and product IDs in association with each other.

A coordinated service order ID (ProductOrder Id) is an identifier of a coordinated service order.

An order execution date and time (requested Start Date) indicates either (i) an execution date and time of a coordinated service order that is a reserved order or (ii) “not specified” that indicates an immediate order. The format of an order execution date and time may, for example, be a DATETIME type (YYYY-MM-DDThh:mm:ss).

An order type (ProductOrder Action) indicates the type of operation performed over a utilized resource by a coordinated service order. Three order types are listed below.
An add-type order (add) is an order to add to a utilized resource a product in which a coordinated service order is instantiated.
An update-type order (modify) is an order concerning a product that is already configured over a utilized resource to update the content thereof. An example of this type of order is to modify the type or the number of CPUs that run a virtual server that is already configured in a cloud.
A delete-type order (delete) is an order concerning a product that has already been configured over a utilized resource to delete the product from the utilized resource.

Note that with regards to the “order execution date and time” and “order type”, not only is it possible for a service provider to specify initial values with an order registration request, but it is also possible to make modifications after registration using an order modification request.

An order state (ProductOrder State) indicates the life cycle status of a coordinated service order, and is specified in the technical specification “TMF622 Product_Ordering_Management_API”. A coordinated service order transitions between the following states.
An Acknowledged state: A state where an issued coordinated service order has been received.
An InProgress state: A state where a coordinated service order that has been in an Acknowledged state has started being executed and is in progress. A reserved order in an Acknowledged state will transition to an InProgress state when an order execution date and time is reached. An immediate order in an Acknowledged state will transition from an Acknowledged state to an InProgress state without delay.
A Held state: A state where the processing of a coordinated service order that has been in an InProgress state is suspended due to an occurrence of an issue such as a conflict over a utilized resource. Once the issue is resolved, the state returns to an InProgress state.
A Completed state: A state where the processing of a coordinated service order that has been in an InProgress state has been completed (a state of successful completion).

A product ID (ProductRef ID), as has been described with FIG. 2, is an identifier for each product that is a coordinated service instantiated over a utilized resource. A product ID is issued when a coordinated service is added (i.e., instantiated) over a utilized resource by an add-type order. A product ID is used without its value being changed when a change to an existing instance is made through a modify-type order or delete-type order.

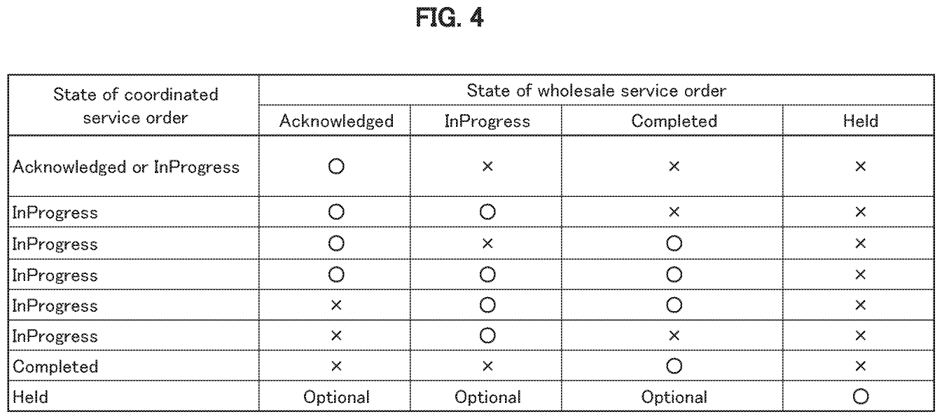

FIG. 4 is a table used by the order execution unit 13 to identify the order state of a coordinated service order from the order states of wholesale service orders. When a set of order states of individual wholesale service orders (“wholesale service order states”) given in the second, third, fourth, and fifth columns is satisfied, the corresponding state given in the first column is identified by the order execution unit 13 as the order state of the coordinated service order (a “coordinated service order state”) that bundles these wholesale service orders.

For example, when wholesale service order states are described by the set (Acknowledged, Completed, Acknowledged), this means that there are two wholesale service orders in an Acknowledged state, none in an InProgress state, one in a Completed state, and none in a Held state. The order execution section 13 refers to the fact that this set of wholesale service order states corresponds to the third row of the table of FIG. 4, and identifies the coordinated service order state as an InProgress state (third row, first column).

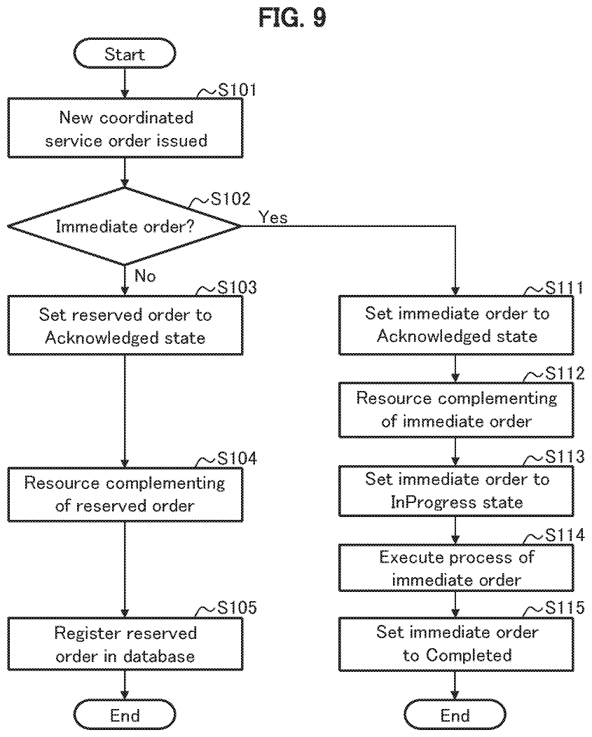

The first row of the table of FIG. 4 indicates that the coordinated service order state is in an “Acknowledged” state until a resource complementing process (described later with reference to step S104 of FIG. 9) is carried out by the execution of a coordinated service order, and is in an “InProgress” state after the resource complementing process has been carried out.

Furthermore, the eighth row of the table of FIG. 4 indicates that when there is even one “Held” state in the set of wholesale service order states, regardless of other wholesale service order states, the coordinated service order state is in a “Held” state.

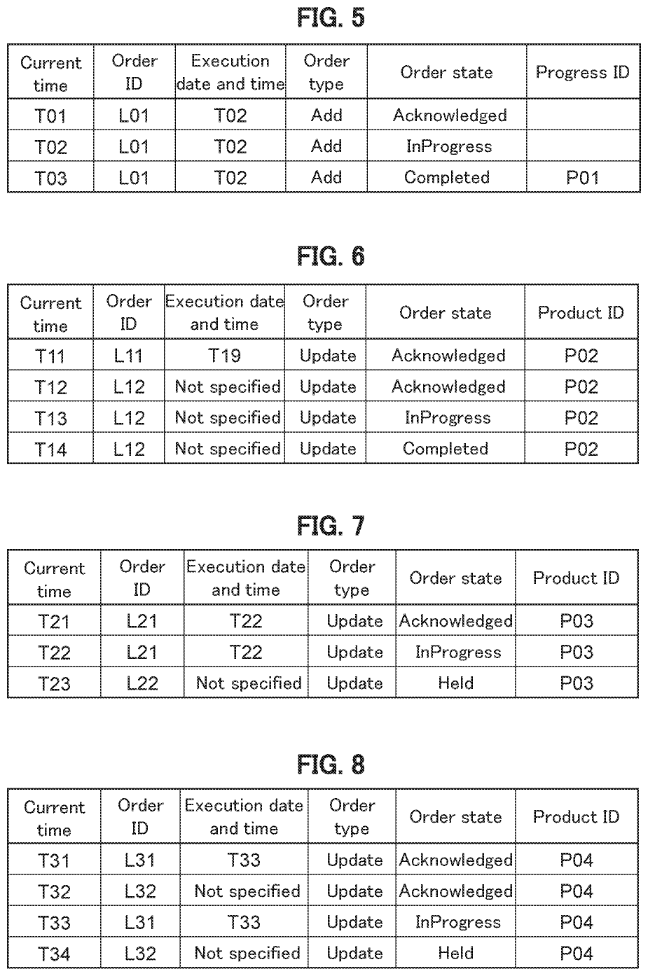

Individual cases of conflicting states between coordinated service orders that are registered in the order management DB 15 are described with reference to FIGS. 5 to 8.

The exclusion control unit 14 resolves conflicting states based on the following control policies.
Policy 1: A conflicting state does not arise between coordinates service orders with different product IDs because utilized resources are different.
Policy 2: When a conflicting state arises between coordinated service orders, an order state at a later stage (an InProgress state) in the order state life cycle is prioritized, and an order state at an earlier stage is made to wait (in a Held state).
Policy 3: In an exclusion check that is carried out at a time when a specific immediate order is received through an order registration request (“an exclusion check at time of receipt of a request”), the specific immediate order is not received if there is another coordinated service order with the same product ID that has preceded to be in an InProgress state.
Policy 4: In an exclusion check that is carried out at a time when a specific coordinated service order that is registered is to be executed (“an exclusion check at time of execution of a request”), the specific coordinated service order is not executed if there is another coordinated service order with the same product ID that has preceded to be in an InProgress state.
Policy 5: In an exclusion check at time of receipt of a request when a specific immediate order is received, the specific coordinated service order is not received if there is another immediate order with the same product ID that is registered with an Acknowledged state.

FIG. 5 is a time-sequential table showing a reserved order transition from an Acknowledged state to a Completed state. Note that in the tables of FIGS. 5-8, column 1 entries indicate the current time and columns 2-6 entries indicate the contents of the order management DB of FIG. 3 (columns 1-5 entries of FIG. 3).

At current time TO1, the order receiving unit 11 receives an order registration request for a reserved order (an add-type order) specified with an order execution date and time of T02.

The order management unit 12 registers the reserved order in an Acknowledged state in the order management DB 15.

At current time T02, the order execution date and time of the reserved order, the order execution unit 13 sets the reserved order that was received at T01 to an InProgress state.

At current time T03, the order execution unit 13 completes the execution of the reserved order that started at T02, and sets the reserved order to a Completed state. In this way, the reserved order is instantiated, and a product ID of P01 is assigned to that instance (the product).

FIG. 6 is a time-sequential table showing the transition of time from when there is a reserved order in an Acknowledged state to when a new immediate order that is initially in an Acknowledged state transitions to a Completed state.

At current time T11, the order receiving unit 11 receives an order registration request for a reserved order (an update-type order) with an order execution date and time specified as T19 (i.e., at a time later than T11-T14). The order management unit 12 registers the reserved order in the Acknowledged state in the order management DB 15.

At the current time T12, the order receiving unit 11 receives an order registration request for an immediate order where an order execution date and time is not specified. Because the reserved order registered in the order management DB 15 with the same product ID is still in an Acknowledged state, a conflict does not arise yet at T12 (policy 3). The order management unit 12 therefore registers the immediate order in the Acknowledged state in the order management DB 15.

At current time T13, the order execution unit 13 sets the immediate order that was received at T12 to an InProgress state. Since the reserved order with the same product ID is still in an Acknowledged state at T13, a conflict does not arise (policy 4).

At current time T14, the order execution unit 13 completes the execution of the immediate order that started at T13 and sets the immediate order to a Completed state.

FIG. 7 is a time-sequential table that begins from when there is a reserved order in an InProgress state to when a new immediate order is set to a Held state.

At current time T21, the order receiving unit 11 receives a reserved order with a specified order execution date and time of T22 and registers the reserved order in the order management DB 15.

At current time T22, because the order execution date and time has arrived, the order execution unit 13 collects the reserved order that was received at time T21 and sets the reserved order to an InProgress state.

At current time T23, the order receiving unit 11 receives a new immediate order. Because there is already a reserved order registered in the order management DB 15 with the same product ID that is in an InProgress state, a conflict arises with the new immediate order (policy 3). The exclusion control unit 14 sends an error notification to a service provider regarding the immediate order that is set to a Held state.

FIG. 8 is a time-sequential table showing an occasion when a reserved order transitions to an InProgress state before a new immediate order can be executed.

At current time T31, the order receiving unit 11 receives a reserved order with a specified order execution date and time of T33 and registers the reserved order in the order management DB 15.

At current time T32, the order receiving unit 11 receives an immediate order. Since the reserved order with the same product ID is still in an Acknowledged state, a conflict does not arise at T32 (policy 3). The order management unit 12 registers the immediate order in an Acknowledged state in the order management DB 15.

At current time T33, because the order execution date and time has arrived, the order execution unit 13 collects the reserved order that was received at T31 and sets the reserved order to an InProgress state.

At current time T34, the order execution unit 13 attempts to execute the immediate order that was received at T32. However, because the reserved order that is registered in the order management DB 15 with the same product ID is already in an InProgress state, a conflict arises with the immediate order of T32 (policy 4). The exclusion control unit 14 sends an error notification to a service provider regarding the immediate order that is set to a Held state.

FIG. 9 is a flowchart showing the steps that are followed when a new add-type order is issued as an order registration request.

In step S101, the order receiving unit 11 receives an order registration request of a coordinated service order newly issued by a service provider.

In step S102, the order receiving unit 11 determines whether the coordinated service order of S101 is an immediate order. If the coordinated service order is without a specified order execution date and time, the coordinated service order is a new immediate order (S102, “Yes”), and the process advances to S111. If the coordinated service order has a specified order execution date and time, the coordinated service order is a new reserved order (S102, “No”), and the process advances to S103.

In step S103, the order execution unit 13 sets the new reserved order to an Acknowledged state.

In step S104, the order execution unit 13 carries out a resource complementing process for the new reserved order. A resource complementing process is a process for generating a command to enable the use of a utilized resource of a coordinated service order by automatically complementing the content of the coordinate service order that has been provided by a service provider. The following is an example of data that has been registered in advance by a maintainer to be complemented, using terms defined in the technical specification TMF622.
ProductOffering
ProductSpecification
ProductSpecCharacteristic
ProductSpecCharacteristicValue

In S105, the order management unit 12 registers the new reserved order that has undergone the resource complementing process of S104 in the order management DB 15. This means that the new reserved order that is registered in S105 is not subject to the exclusion check at time of receipt of a request that is indicated in policy 3.

In step S111, the order execution unit 13 sets the new immediate order to an Acknowledged state.

In step S112, the order execution unit 13 carries out a resource complementing process for the new immediate order, in the same way as S104.

In step S113, the order execution unit 13 sets the new immediate order to an InProgress state.

In step S114, the order execution unit 13 executes the process of the new immediate order.

In step S115, the order execution unit 13 sets the new immediate order to a Completed state.

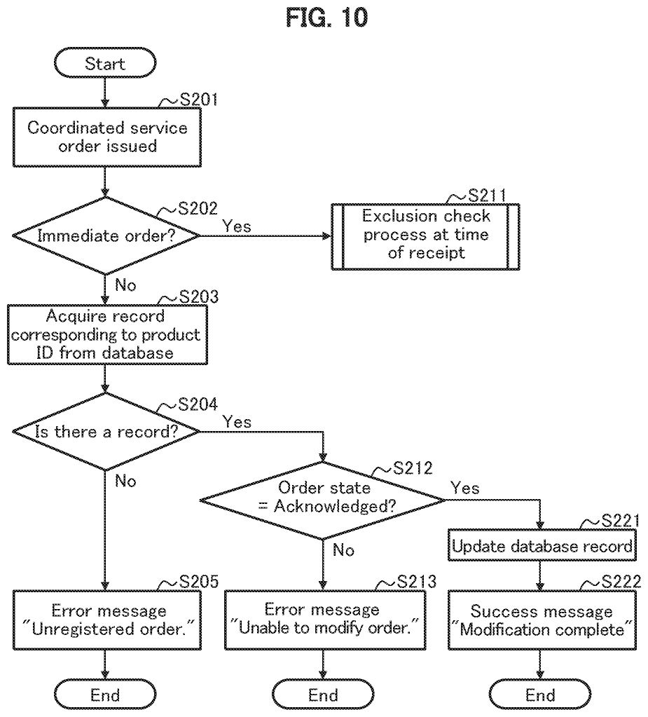

FIG. 10 is a flowchart showing steps that are followed when an order modification request for a registered coordinated service order is received.

In step S201, the order receiving unit 11 reads from the received order modification request various types of information (an order execution date and time, a product ID, an order state set to Acknowledged state) of the coordinated service order that is subject to the order modification request issued by a service provider.

In step S202, the order receiving unit 11 determines, based on the order execution date and time read in step S201, whether the coordinated service order that is subject to modification is an immediate order. If the answer is yes (S202, “Yes”), the process advances to step S211, where the exclusion check process at time of receipt (the check process of policy 3) is called. If the answer is no (S202, “No”), the process advances to step S203.

In step S203, the order management unit 12 acquires a record that corresponds to the product ID read in step S201 from the order management DB 15.

In step S204, the order management unit 12 determines whether the record that was acquired in step S203 (i.e., a record with an identical product ID) exists. If the answer is yes (S204, “Yes”), the process advances to step S212. If the answer is no (S204, “No”), then to step S205.

In step S205, the order management unit 12 returns an error message with the following information to the service provider via the order receiving unit 11: “The coordinated service order for which an order modification request has been made is not registered in the order management DB 15.”

In step S212, the order management unit 12 determines whether the order state provided in the record acquired in step S203 is an Acknowledged state. If the answer is yes (step S212, “Yes”), the process advances to step S221, and if the answer is no (step S212, “No”), to step S213.

In step S213, the order management unit 12 returns an error message with the following information to the service provider via the order receiving unit 11: “The coordinated service order for which an order modification request has been made is already in progress. Contents of the order cannot be modified.”

In step S221, the order management unit 12 permits the modification of the coordinated service order for which the order modification request has been made and modifies the content of the order management DB 15 according to the order modification request. Note that an operation to delete a record of a coordinated service order in the order management DB 15 may be received as an order modification request by specifying the order execution date and time to a very far future (such as one hundred years from the current time).

In step S222, the order management unit 12 returns a normal response message with the following information to the service provider via the order receiving unit 11: “The coordinated service order for which an order modification request was made has been modified.”

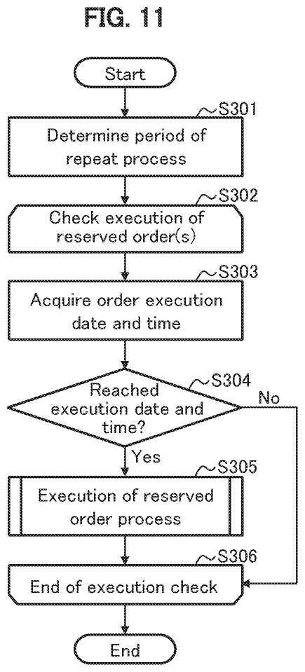

FIG. 11 is a flowchart showing the process where at least one reserved order whose order execution date and time has arrived is read from the order management DB 15.

In step S301, the order management unit 12 reads an external configuration file that has been prepared in advance and determines the cycle period, say, in seconds, of a repeat process for checking reserved order execution (steps S302 to S306). This cycle period indicates the time interval between checks to see whether the respective order execution date and time has arrived for each reserved order that is registered in the order management DB 15.

In step S303, the order management unit 12 acquires the order execution date and time of each reserved order registered in the order management DB 15. Note that the order management unit 12 may, instead of accessing the order management DB 15 directly, access an external file that lists the order execution date and time of each reserved order to carry out the process of step S303.

In step S304, the order management unit 12 determines whether there is at least one reserved order for which the current time has passed the respective order execution date and time. If the answer is yes (S304, “Yes”), the process advances to step S305, and if the answer is no (S304, “No”), to step S306.

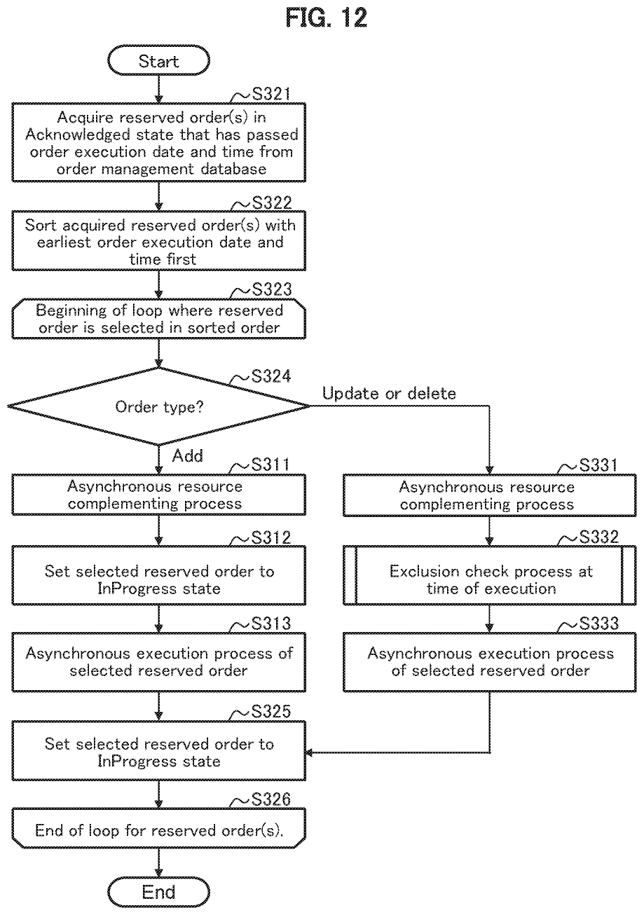

In step S305, the order management unit 12 calls the process shown in FIG. 12 in order to collect the at least one reserved order from the order management DB 15 and to execute the at least one reserved order. Note that when there are multiple reserved orders whose order execution date and time has passed, individual reserved orders are executed through asynchronous processing. In other words, a second reserved order may begin execution before the execution of a first reserved order is complete.

FIG. 12 is a flowchart showing details of a process for executing at least one reserved order that is called from step S305.

In step S321, the order management unit 12 acquires from the order management DB 15 at least one reserved order that is in an Acknowledged state and for which the current time has passed the respective order execution date and time.

In step S322, the order management unit 12 sorts the at least one reserved order in chronological order, starting with the reserved order with the earliest execution date and time. Note that when there are reserved orders with the same order execution date and time, the order management unit 12 sorts those reserved orders in the order of the time of registration to the order management DB 15, with the reserved order with the earliest time of registration coming first.

In steps S323 to S326, the order management unit 12 carries out a loop process for a reserved order that is selected from the at least one reserved order in the sorted order. In step S324, the order management unit 12 branches to different steps depending on the order type of the selected reserved order. If the order type is an add-type order, the process advances to step S311. If order type is an update-type order or a delete-type order, the process advances to step S331.

In step S311, the order execution unit 13 executes a resource complementing process for the selected reserved order as in step S104. The resource complementing process is executed asynchronously.

In step S312, the order execution unit 13 sets the selected reserved order to an InProgress state.

In step S313, the order execution unit 13 executes the selected reserved order asynchronously.

In step S325, the order execution unit 13 sets the selected reserved order to an InProgress state as in step S312.

In step S331, the order execution unit 13 executes a resource complementing process for the selected reserved order as in step S104. The resource complementing process is executed asynchronously.

In step S332, the order execution unit 13 calls the exclusion check process at time of execution (check process of policy 4) shown in FIG. 15.

In step S333, the order execution unit 13 executes the selected reserved order asynchronously.

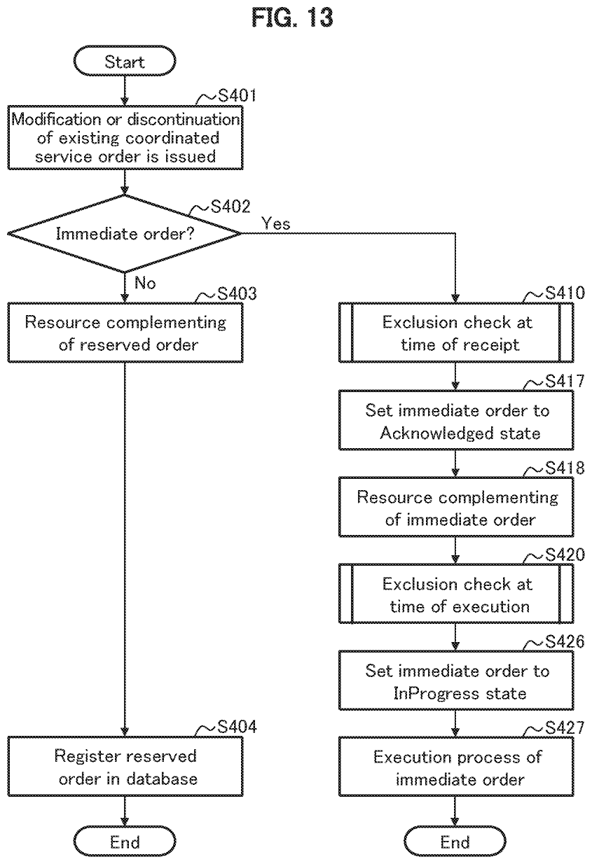

FIG. 13 is a flowchart showing the process when a new update-type order or delete-type order is issued as an order registration request.

In step S401, the order receiving unit 11 receives an order registration request regarding an update-type order or a delete-type order for an existing product ID.

In step S402, the order receiving unit 11 determines whether the coordinated service order of step S401 is an immediate order. If the answer is yes (S402, “Yes”), the process advances to step S410, and if the answer is no (S402, “No”), to step S403.

In step S403, the order execution unit 13 executes a resource complementing process for the reserved order of step S401 as in step S104.

In step S404, the order management unit 12 registers the reserved order of step S401 in the order management DB 15.

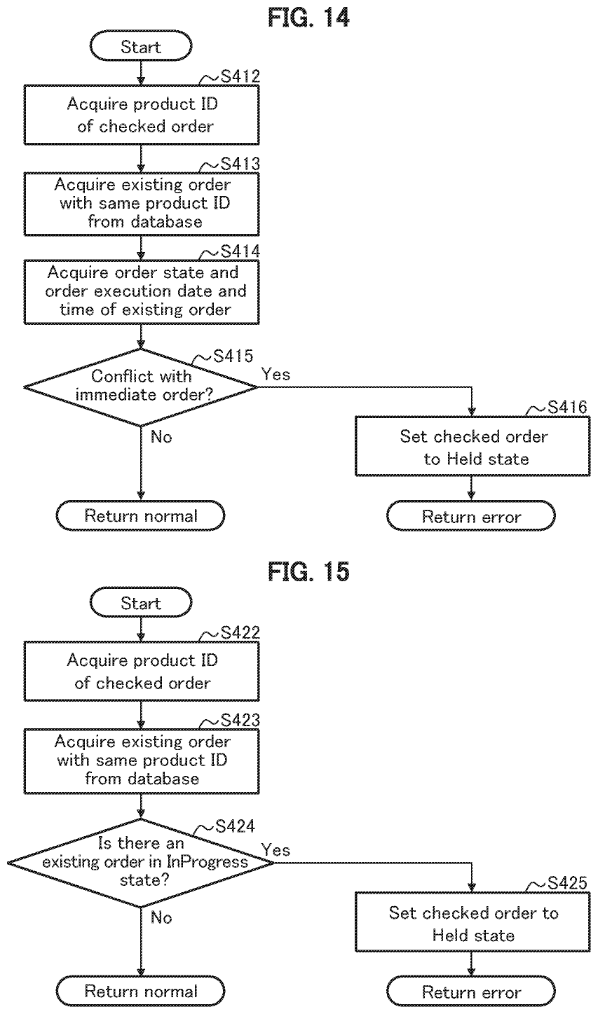

In step S410, the order execution unit 13 calls the exclusion check process at time of receipt (checking process of policy 3) shown in FIG. 14 for the immediate order of step S401.

In step S417, the order execution unit 13 sets the immediate order of step S401 to an Acknowledged state.

In step S418, the order execution unit 13 executes a resource complementing process for the immediate order of step S401 as in step S104.

In step S420, the order execution unit 13 calls the exclusion check process at time of execution (checking process of policy 4) shown in FIG. 15.

In step S426, the order execution unit 13 sets the immediate order of step S401 to an InProgress state.

In step S427, the order execution unit 13 executes the process of the immediate order of step S401.

FIG. 14 is a flowchart showing details of the exclusion check process at time of receipt that is called from step S211 and S410 with a coordinated service order that is to be checked specified.

In step S412, the exclusion control unit 14 acquires the product ID that the coordinated service order being checked deals with from the order management DB 15.

In step S413, the exclusion control unit 14 acquires from the order management DB 15 an existing coordinated service order with the same product ID as the product ID acquired in step S412 (making that existing coordinated service order a possible conflicting order according to policy 1). When no existing coordinated service order is acquired in step S413, the process does not advance to step S414 and returns a normal check result indicating no conflict to the caller (not shown in figure).

In step S414, the exclusion control unit 14 acquires from the order management DB 15 the order state and the order execution date and time of the existing coordinated service order acquired in step S413.

In step S415, the exclusion control unit 14 determines whether there is a conflict between the coordinated service order being checked and the existing coordinated service order with a common product ID. For example, if the existing coordinated service order is in an InProgress state, a conflict does exist as indicated by policy 3. Even when the existing coordinated service order is in an Acknowledged state, if the existing coordinated service order is an immediate order, a conflict does exist as indicated by policy 5. If the answer to step S415 is yes, the process advances to step S416, and if the answer is no, a normal check result indicating no conflict is returned to the caller.

In step S416, in order to prioritize the existing coordinated service order with which there is a conflicting state, the exclusion control unit 14 sets the coordinated service order being checked to a Held state (according to policy 2), and returns an error to the service provider.

FIG. 15 is a flowchart showing details of the exclusion check process at time of execution that is called from step S332 and S420.

In step S422, the exclusion control unit 14 acquires the product ID that the coordinated service order being checked deals with from the order management DB 15.

In step S423, the exclusion control unit 14 acquires from the order management DB 15 an existing coordinated service order with the same product ID as the product ID acquired in step S422 (making the existing coordinated service order a possible conflicting order according to policy 1). When there is no existing coordinated service order acquired in step S423, the process does not advance to step S424 but returns a normal check result indicating no conflict to the caller (not shown in figure).

In step S424, the exclusion control unit 14 determines whether there is a conflict between the coordinated service order being checked and the existing coordinated service order with the common product ID. For example, if the existing coordinated service order is in an InProgress state, a conflict exists as indicated by policy 4. If the answer in step S424 is yes, the process advances to step S425, and if the answer is no, a normal check result indicating no conflict is returned to the caller.

In step S425, the exclusion control unit 14 sets the coordinated service order being checked to a Held state in order to prioritize the existing coordinated service order with which there is a conflicting state (policy 2) and furthermore returns an error to the service provider.

In the embodiment described above, the order management unit 12 that manages the order management DB 15 can not only handle an order registration request to the order management DB 15 as shown in FIG. 9, but can also handle an order modification request for a registered coordinated service order (FIG. 10).

Furthermore, the exclusion control unit 14 exerts control to avoid conflict among multiple coordinated service orders that use the same utilized resource at the same time as shown in FIGS. 14 and 15. The exclusion control unit 14 follows the policies 1 to 5 when determining among which coordinated service orders a conflict arises and which coordinated service order to prioritize and to continue processing over other conflicting coordinated service orders. In this way, it is possible to carry out appropriate management of coordinated service orders that implement coordinated services.

Note that in describing the above embodiment, although the coordinated services according to the present invention has been explained using those configured from the three wholesale services of FIG. 1, the invention is not limited to coordinated serves of the same configuration or the same number of wholesale services. Note also that the invention may be realized with a program that operates a general computer hardware resource as individual means of the service coordination device 1. This program may then be distributed via a communication channel or via a storage medium such as CD-ROM onto which the program is stored.

1. A service coordination device comprising
(a) an order receiving unit, including one or more processors, configured to accept a coordinated service order, wherein the coordinated service order executes a coordinated service linking multiple services;
(b) an order management unit, including one or more processors, configured to register the coordinated service order received by the order receiving unit in an order management database;
(c) an order execution unit, including one or more processors, configured to execute the registered coordinated service order that is read from the order management database so as to process an instance of the coordinated service generated over a utilized resource of the coordinated service; and
(d) an exclusion control unit, including one or more processors, configured to carry out exclusion control among coordinated service orders by prioritizing a coordinated service order that is executed first among conflicting coordinated service orders targeting to process a same instance and preventing other ones of the conflicting coordinated service orders from being executed before the conflicting coordinated service orders are executed by the order execution unit at the same time.

2. The service coordination device according to claim 1, wherein
the order execution unit is further configured to set the coordinated service order that is read from the order management database and executed to an InProgress state, wherein when a new coordinated service order is received by the order receiving unit, the exclusion control unit is configured to prevent the new coordinated service order from being registered in the order management database if there is at least one conflicting coordinated service order that is in an InProgress state.

3. The service coordination device according to claim 1, wherein
the order execution unit is further configured to set the coordinated service order that is read from the order management database and executed to an InProgress state, wherein
when a specific coordinated service order is read from the order management database to be executed, the exclusion control unit is configured to prevent the specific coordinated service order from being executed if there is a conflicting coordinated service order that is in an InProgress state.

4. The service coordination device according to claim 1, wherein
the order receiving unit is further configured to individually register as an Acknowledged state a reserved order with a specified order execution date and time and an immediate order not specified with an order execution date and time in the order management database, wherein
when the order receiving unit receives a new immediate order, the exclusion control unit is configured to prevent the new immediate order from being registered in the order management database if there is a conflicting immediate order that is in an Acknowledged state.

5. The service coordination device according to claim 4, wherein
when an order modification request to modify either an order execution date and time or a processing content of an instance for a reserved order registered in the order management database is received, the order management unit is configured to search a corresponding reserved order from the order management database, and if the corresponding reserved order is not registered in the order management database or is not in an Acknowledged state, to not reflect the order modification request in the order management database.

6. A service coordination method executed by a service coordination device comprising an order receiving unit, an order management database, an order management unit, an order execution unit, and an exclusion control unit, the service coordination method comprising:
(a) configuring the order receiving unit to accept a coordinated service order for executing a coordinated service linking multiple services;
(b) configuring the order management unit to register the coordinated service order received by the order receiving unit in the order management database;
(c) configuring the order execution unit to execute the registered coordinated service order that is read from the order management database in order to process an instance of the coordinated service generated over a utilized resource of the coordinated service; and
(d) configuring the exclusion control unit to carry out exclusion control among coordinated service orders targeting to process a same instance by prioritizing a coordinated service order that is executed first among conflicting coordinated service orders and preventing other ones of the conflicting coordinated service orders from being executed before the order execution unit executes the conflicting coordinated service orders at the same time.

7. The service coordination method according to claim 6, wherein
the order execution unit is further configured to set the coordinated service order that is read from the order management database and executed to an InProgress state, wherein
when a new coordinated service order is received by the order receiving unit, the exclusion control unit is configured to prevent the new coordinated service order from being registered in the order management database if there is at least one conflicting coordinated service order that is in an InProgress state.

8. The service coordination method according to claim 6, wherein
the order execution unit is further configured to set the coordinated service order that is read from the order management database and executed to an InProgress state, wherein
when a specific coordinated service order is read from the order management database to be executed, the exclusion control unit is configured to prevent the specific coordinated service order from being executed if there is a conflicting coordinated service order that is in an InProgress state.

9. The service coordination method according to claim 6, wherein
the order receiving unit is further configured to individually register as an Acknowledged state a reserved order with a specified order execution date and time and an immediate order not specified with an order execution date and time in the order management database, wherein
when the order receiving unit receives a new immediate order, the exclusion control unit is configured to prevent the new immediate order from being registered in the order management database if there is a conflicting immediate order that is in an Acknowledged state.

10. The service coordination method according to claim 9, wherein when an order modification request to modify either an order execution date and time or a processing content of an instance for a reserved order registered in the order management database is received, the order management unit is configured to search a corresponding reserved order from the order management database, and if the corresponding reserved order is not registered in the order management database or is not in an Acknowledged state, to not reflect the order modification request in the order management database.
